(19) United States
(12) Patent Application Publication
(10) Pub. No.: US 2017/0352208 A1
(43) Pub. Date: Dec. 7, 2017

(54) Article Delivery Assembly

(71) Applicant: Jason Calvert, Farmdale, OH (US)

(72) Inventor: Jason Calvert, Farmdale, OH (US)

(21) Appl. No.: 15/173,193

(22) Filed: Jun. 3, 2016

(51) Int. Cl. G07C 9/00; E05B 65/00

(52) U.S. Cl. CPC G07C 9/00111; E05B 65/0075; G07C 9/00182

(57) ABSTRACT

An article delivery assembly for unattended, trackable and secure delivery of articles includes a box that defines an internal space. A door is hingedly coupled to the box and is positioned to cover an open face of the box. A locking mechanism, a power module, a microprocessor and a reader are coupled to a back of the door. A keypad and a first antenna are coupled to a front of the door. The locking mechanism is selectively couplable to the box. The microprocessor is operationally coupled to the power module. The reader and the keypad are operationally coupled to the microprocessor. The first antenna is operationally coupled to the reader. A fastener, coupled to the box, is configured to attach the box to a substrate. Each of a plurality of tags, readable by the reader, is configured to couple to an article to be positioned in the internal space.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to article delivery assemblies and more particularly pertains to a new article delivery assembly for unattended, trackable and secure delivery of articles.

### BRIEF SUMMARY OF THE INVENTION

An embodiment of the disclosure meets the needs presented above by generally comprising a box that defines an internal space. A door is hingedly coupled to the box and is positioned to cover an open face of the box. A locking mechanism, a power module, a microprocessor and a reader are coupled to a back of the door. A keypad and a first antenna are coupled to a front of the door. The locking mechanism is selectively couplable to the box. The microprocessor is operationally coupled to the power module. The reader and the keypad are operationally coupled to the microprocessor. The first antenna is operationally coupled to the reader. A fastener, coupled to the box, is configured to attach the box to a substrate. Each of a plurality of tags, readable by the reader, is configured to couple to an article to be positioned in the internal space.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an article delivery assembly according to an embodiment of the disclosure.

FIG. 2 is a side view of an embodiment of the disclosure.

FIG. 3 is an isometric perspective view of an embodiment of the disclosure.

FIG. 4 is a front view of an embodiment of the disclosure.

FIG. 5 is a front view of an embodiment of the disclosure.

FIG. 6 is a block diagram of an embodiment of the disclosure.

### DETAILED DESCRIPTION OF THE INVENTION

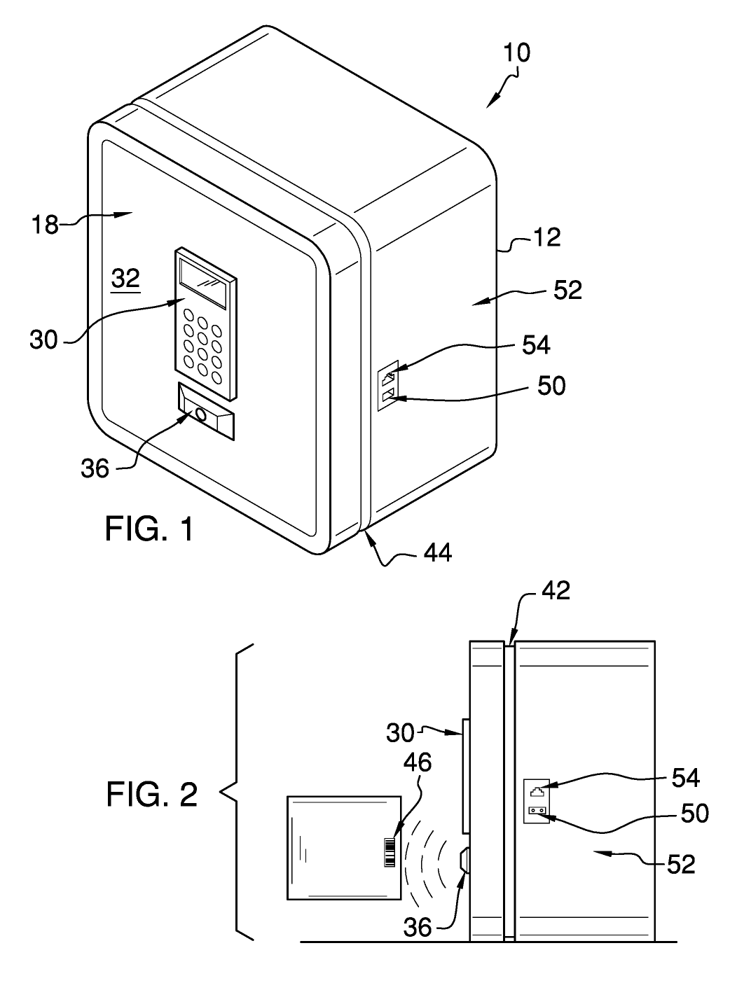

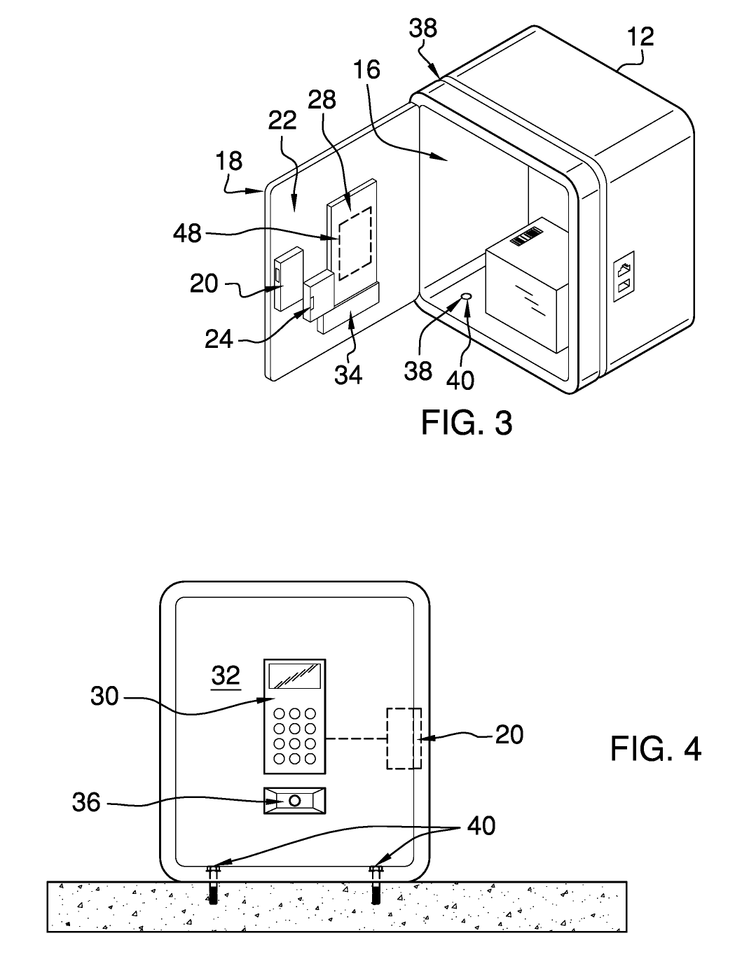

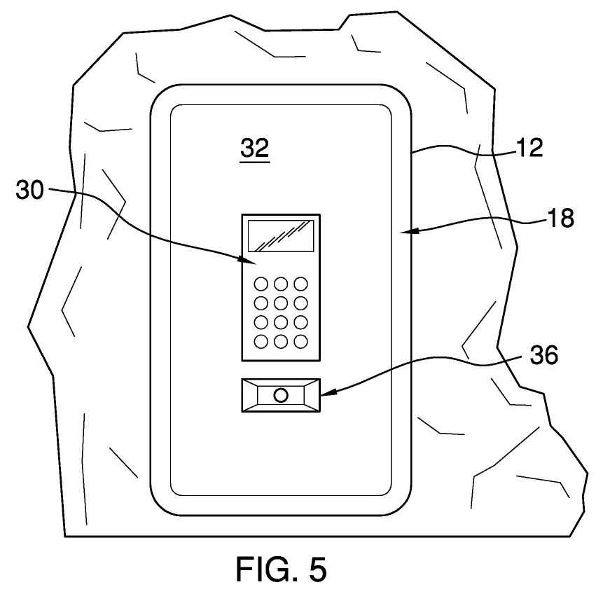

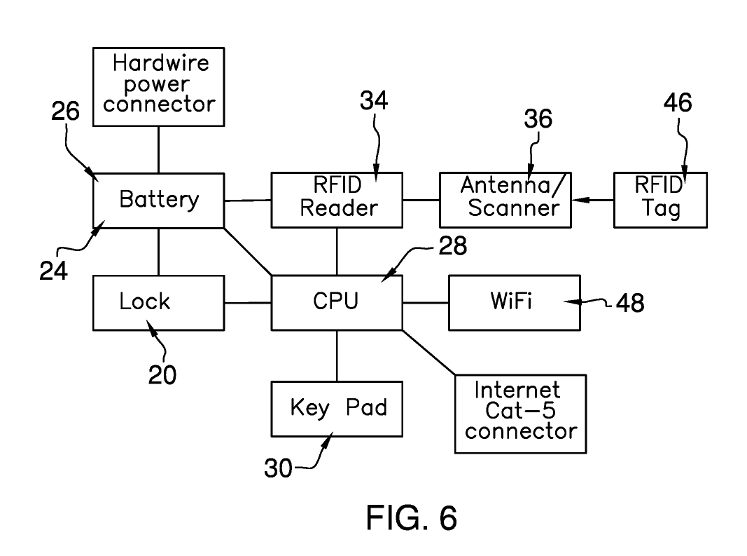

With reference now to the drawings, and in particular to FIGS. 1 through 6 thereof, a new article delivery assembly embodying the principles and concepts of an embodiment of the disclosure and generally designated by the reference numeral 10 will be described.

As best illustrated in FIGS. 1 through 6, the article delivery assembly 10 generally comprises a box 12 that defines an internal space 14. The box 12 has an open face 16. A door 18 is hingedly coupled to the box 12. The door 18 is positioned to cover the open face 16 of the box 12. The box 12 is substantially rectangularly box 12 shaped. The door 18 and the box 12 comprises steel. In one embodiment the door 18 and the box 12 comprises carbon steel.

A locking mechanism 20 is coupled to a back 22 of the door 18. The locking mechanism 20 is selectively couplable to the box 12. The locking mechanism 20 is positioned to couple to the box 12 to secure the door 18 over the open face 16. The locking mechanism 20 also is positioned to decouple from the box 12 such that the door 18 is openable.

A power module 24 is coupled to the back 22 of the door 18. The power module 24 comprises at least one battery 26. A microprocessor 28 is coupled to the back 22 of the door 18. The microprocessor 28 is operationally coupled to the power module 24.

A keypad 30 is coupled to a front 32 of the door 18. The keypad 30 is operationally coupled to the microprocessor 28. The keypad 30 is configured for entry of a code to compel the locking mechanism 20 to decouple from the box 12 so that the door 18 is openable.

A reader 34 is coupled to the back 22 of the door 18. The reader 34 is operationally coupled to the microprocessor 28. The reader 34 is radio frequency enabled. A first antenna 36 is coupled to the front 32 of the door 18. The first antenna 36 is operationally coupled to the reader 34.

A fastener 38 is coupled to the box 12. The fastener 38 is configured to attach the box 12 to a substrate to deter theft of the box 12. In one embodiment, the fastener 38 comprises a plurality of holes 40 positioned through a bottom of the box 12. The plurality of holes 40 comprises four holes 40. In another embodiment, the fastener 38 comprises a recess 42 positioned in the box 12 around a perimeter 44 of the box 12. The recess 42 is configured to receive a flange that is coupled to the substrate, such that the box 12 is coupled to the substrate.

The assembly 10 comprises a plurality of tags 46 that is readable by the reader 34. Each tag 46 is configured to couple to a respective article that is to be positioned in the internal space 14. The tags 46 are radio frequency enabled.

A second antenna 48 is operationally coupled to the microprocessor 28. The second antenna 48 is enabled for wireless communication. The second antenna 48 is configured to communicate delivery information to a computer network.

A first connector 50 is coupled to the box 12. The first connector 50 is operationally coupled to the microprocessor 28. The first connector 50 is configured to couple to a power source. In one embodiment, the first connector 50 is positioned on a side 52 of the box 12.

A second connector 54 is coupled to the box 12. The second connector 54 is operationally coupled to the microprocessor 28. The second connector 54 is configured to couple to a computer network. In one embodiment, the second connector 54 is positioned on the side 52 of the box 12.

The present invention also anticipates a bar code that is coupled to the front 32 of the door 18. The bar code would be configured to be read by a delivery agent for tracking purposes. Additionally, the present invention anticipates a proximity sensor that is coupled to the microprocessor 28. The proximity sensor would be configured to alert a user of activity near the box 12 via the computer network.

In use, the reader 34 is positioned to receive a signal from a respective tag 46 positioned on a respective article. The reader 34 is positioned to relay the signal to the microprocessor 28. The microprocessor 28 is positioned to compel the locking mechanism 20 to decouple from the box 12 such that the door 18 is openable. Alternatively, the keypad 30 is configured for entry of a code to compel the locking mechanism 20 to decouple from the box 12 to such that the door 18 is openable. The second antenna 48 is configured to communicate delivery information to a user via the computer network.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An article delivery assembly comprising:
a box, said box defining an internal space, said box having an open face;
a door hingedly coupled to said box, said door being positioned to cover said open face of said box;
a locking mechanism coupled to a back of said door, said locking mechanism being selectively couplable to said box, wherein said locking mechanism is positioned to couple to said box to secure said door over said open face, and wherein said locking mechanism is positioned to decouple from said box to such that said door is openable;
a power module coupled to said back of said door;
a microprocessor coupled to said back of said door, said microprocessor being operationally coupled to said power module;
a keypad coupled to a front of said door, said keypad being operationally coupled to said microprocessor, wherein said keypad is configured for entry of a code to compel said locking mechanism to decouple from said box such that said door is openable;
a reader coupled to said back of said door, said reader being operationally coupled to said microprocessor;
a first antenna coupled to said front of said door, said first antenna being operationally coupled to said reader;
a fastener coupled to said box, wherein said fastener is configured for attachment of said box to a substrate to deter theft of said box;
a plurality of tags readable by said reader, each of said plurality of tags being configured to couple to one of a plurality of respective articles to be positioned in said internal space; and
wherein said reader is positioned to receive a signal from each respective said tag coupled to each respective article, such that said reader is positioned to relay the signal to said microprocessor, wherein said microprocessor is positioned to compel said locking mechanism to decouple from said box such that said door is openable.

2. The assembly of claim 1, further including said box being substantially rectangularly box shaped.

3. The assembly of claim 1, further including said door and said box comprising steel.

4. The assembly of claim 3, further including said door and said box comprising carbon steel.

5. The assembly of claim 1, further including said power module comprising at least one battery.

6. The assembly of claim 1, further including said reader and said tags being radio frequency enabled.

7. The assembly of claim 1, further including said fastener comprising a plurality of holes positioned through a bottom of said box.

8. The assembly of claim 7, further including said plurality of holes comprising four said holes.

9. The assembly of claim 1, further including said fastener comprising a recess positioned in said box around a perimeter of said box, wherein said recess is configured to receive a flange coupled to the substrate, such that said box is coupled to the substrate.

10. The assembly of claim 1, further including a second antenna operationally coupled to said microprocessor, said second antenna being enabled for wireless communication, wherein said second antenna is configured to communicate delivery information to a computer network.

11. The assembly of claim 1, further including a first connector coupled to said box, said first connector being operationally coupled to said microprocessor, said first connector being configured for coupling to a power source.

12. The assembly of claim 11, further including said first connector being positioned on a side of said box.

13. The assembly of claim 1, further including a second connector coupled to said box, said second connector being operationally coupled to said microprocessor, said second connector being configured for coupling to a computer network.

14. The assembly of claim 13, further including said second connector being positioned on a side of said box.

15. An article delivery assembly comprising:
a box, said box defining an internal space, said box having an open face;
a door hingedly coupled to said box, said door being positioned to cover said open face of said box, said box being substantially rectangularly box shaped, said door and said box comprising steel, said door and said box comprising carbon steel;
a locking mechanism coupled to a back of said door, said locking mechanism being selectively couplable to said box, wherein said locking mechanism is positioned to couple to said box to secure said door over said open face, and wherein said locking mechanism is positioned to decouple from said box to such that said door is openable;
a power module coupled to said back of said door, said power module comprising at least one battery;
a microprocessor coupled to said back of said door, said microprocessor being operationally coupled to said power module;
a keypad coupled to a front of said door, said keypad being operationally coupled to said microprocessor, wherein said keypad is configured for entry of a code to compel said locking mechanism to decouple from said box such that said door is openable;
a reader coupled to said back of said door, said reader being operationally coupled to said microprocessor, said reader being radio frequency enabled;
a first antenna coupled to said front of said door, said first antenna being operationally coupled to said reader;
a fastener coupled to said box, wherein said fastener is configured for attachment of said box to a substrate to deter theft of said box;
a plurality of tags readable by said reader, each of said plurality of tags being configured to couple to one of a plurality of respective articles to be positioned in said internal space, said tags being radio frequency enabled;
a second antenna operationally coupled to said microprocessor, said second antenna being enabled for wireless communication, wherein said second antenna is configured to communicate delivery information to a computer network;
a first connector coupled to said box, said first connector being operationally coupled to said microprocessor, said first connector being configured for coupling to a power source, said first connector being positioned on a side of said box;
a second connector coupled to said box, said second connector being operationally coupled to said microprocessor, said second connector being configured for coupling to a computer network, said second connector being positioned on a side of said box; and
wherein said reader is positioned to receive a signal from each respective said tag coupled to each respective article, such that said reader is positioned to relay the signal to said microprocessor, wherein said microprocessor is positioned to compel said locking mechanism to decouple from said box such that said door is openable, wherein said second antenna is configured to communicate delivery information to a user via a computer network.
